(19) United States
(12) Patent Application Publication
(10) Pub. No.: US 2026/0097611 A1
(43) Pub. Date: Apr. 9, 2026

(54) VEHICLE WHEEL TYRE

(71) Applicant: PIRELLI TYRE S.P.A., Milano (IT)

(72) Inventors: Giovanni CASAROTTO, MILANO (IT); Diego Ettore SPEZIARI, MILANO (IT); Riccardo GUERRA, MILANO (IT)

(21) Appl. No.: 19/106,990

(22) PCT Filed: Oct. 19, 2023
(86) PCT No.: PCT/IB2023/060557

§ 371 Date: Feb. 26, 2025

(30) Foreign Application Priority Data
Nov. 3, 2022 (IT) 102022000022551

(51) Int. Cl. B60C 11/03

(52) U.S. Cl. CPC B60C 11/0309; B60C 11/0302; B60C 2011/0339

(57) ABSTRACT

A tyre includes a tread band, a tread surface which is radially external to the tread band, and a plurality of blocks formed on the tread band. Each block is at least partially delimited by a groove which defines a flank of the block. The flank is joined to a tread surface portion. The tread surface portion is defined on the block in the region of an edge of the block. There are, on a portion of the edge, a plurality of consecutive recesses and, in the region of at least two of these recesses, there is a respective block portion which defines a protrusion. The protrusion projects from the flank of the block towards the inner side of the groove and extends as far as a bottom of the groove.

The present invention relates to a tyre for vehicle wheels, particularly a winter tyre. A tyre generally comprises a carcass structure which is shaped toroidally about a rotation axis and which includes at least one carcass ply which has terminal rims which engage in respective annular anchoring structures, known as bead cores.

In a radially external position with respect to the carcass structure, there is provided a belt structure comprising, in the case of tyres for cars, at least two radially superimposed strips of rubberized fabric provided with reinforcement cords, which are usually made of metal and which are arranged in each strip in a mutually parallel manner but cross-wise with respect to the cords of the adjacent strip, preferably symmetrically with respect to the equatorial plane of the tyre.

Preferably, the belt structure further also comprises in a radially external position, at least at the ends of the belt strips below, a third layer of textile or metal cords which are arranged circumferentially (at 0 degrees). In tyres of the tubeless type, there is further present a radially internal layer called a liner which has characteristics of impermeability in order to ensure the air-tightness for the tyre itself.

In a radially external position with respect to the belt structure, there is applied a tread band which is made of elastomer material and on which there is defined a tread surface which is intended for contact with the road surface.

Tyres, in order to ensure adequate road grip even on a wet road surface, have a tread band which is provided with grooves of various shape and geometries, the main function of which is to allow the discharge of the water present between the surface of the tyre and the road surface during mutual contact, preventing the hydrostatic pressure resulting from the impact of the water against the advancing tyre from being able to cause even partial lifting of the tyre off the road surface and the consequent loss of control of the vehicle (phenomenon known as “aquaplaning”).

The grooves which are formed in a circumferential direction further have an influence on the characteristics of directionality and stability of travel of the tyre in relation to the capacity of the tyre to withstand the tangential stresses parallel with the rotation axis of the tyre.

The grooves formed in a transverse direction in turn influence the traction characteristics of the tyre, that is to say, the capacity to transmit to the road surface the tangential stresses parallel with the direction of travel, in particular during the acceleration and braking steps of the motor vehicle.

The grooves generally define on the tread band a plurality of blocks, each of which comprises a radially external surface which is intended for contact with the road surface and which therefore forms a portion of the tread surface of the tyre. In the case of a winter tyre, there are generally formed on the blocks of the tread band small notches, called “sipes”, which extend from the tread surface of the tyre towards the interior of the block. The function of the sipes is to provide additional grip elements in the case of travel on a snow-bound surface and to retain a specific quantity of snow, thereby improving the grip with respect to the road surface.

Each block is further delimited, at least partially, by one or more flanks which are defined by the side walls of the grooves which surround it. Each flank is joined to the radially external surface of the tyre by a respective edge which, in turn, may have a chamfer or a sharp edge.

Generally, the flanks of the block extend parallel with the longitudinal direction of the groove which defines them, but in some cases one or more flanks of a block may have a conformation with a non-linear profile, which is formed by a succession of projections and recesses and which defines an edge with a zig-zag progression.

An example of a winter tyre which is provided with blocks shaped in this manner is described in US 2003/0029537.

Another example of a winter tyre having blocks which are shaped in this manner is described in EP 3375639. In fact, this last document describes a winter tyre having shoulder blocks, one flank of which has, in an axially internal portion thereof, a succession of projections and recesses which define a zig-zag progression of the corresponding edge. On said flank, in an axially external portion thereof, there is further formed a recess, the bottom of which is raised with respect to the bottom of the groove so as to form a step which extends towards the axial end of the tread band.

The term “circumferential” direction is intended to be a direction which is generally directed in the rotation direction of the tyre or which, in any case, is slightly inclined (at most by approximately 5°) with respect to the rotation direction of the tyre.

The term “axial” direction is intended to be a direction which is substantially parallel with the rotation axis of the tyre or which, at most, slightly inclined (at most by approximately 5°) with respect to this rotation axis of the tyre. The axial direction is generally perpendicular to the circumferential direction.

The term “radial” direction is intended to be a direction which is substantially perpendicular to the rotation axis of the tyre or at most which is slightly inclined (at most by approximately 5°) with respect thereto, and which extends through this rotation axis of the tyre. In other words, the radial direction belongs to a plane which is perpendicular to the rotation axis of the tyre and which intersects with this rotation axis.

In particular, it may be noted that, when the radial direction is mentioned with reference to an element of the tread band, such as, for example, a groove, a block or a component thereof, it is intended to be understood the radial direction extending through this element.

The term “equatorial plane” of the tyre is intended to be an axial centre plane which is perpendicular to the rotation axis of the tyre.

The term “shoulder region” of the tread band is intended to be the portions of tread band which extend circumferentially in an axially external position with respect to the tread band itself. Preferably, each shoulder region extends over a width equal to at least 10% of the width of the tread band.

The term “groove” is intended to be a recess which is formed in a tread band portion and which has a width greater than or equal to 1.5 mm and, preferably, a depth greater than 3 mm.

The term “sipe” is intended to be a recess which is formed in a tread band portion and which has a width less than 1.5 mm, preferably less than or equal to 1 mm.

The term “block” is intended to be a tread band portion which is delimited by at least one groove, preferably by at least two different grooves, and on which there is defined on the radially external surface thereof a tread surface portion which is intended for contact with the road surface.

Therefore, blocks are considered to be both a tread band portion with a closed contour which is delimited by three or more grooves and a circumferential rib which is delimited by a pair of grooves which develop circumferentially around the tread band.

A “central block” is defined as a block which is not delimited by the axial ends of the tread band while a block which is partially delimited by one of the axial ends of the tread band is defined as a “shoulder block”.

The term “flank” of a block is intended to be the surface which generally extends towards the tread surface portion of the block from a bottom of a groove which delimits the block.

The term “inclination” of a flank is intended to be the direction of maximum inclination of the flank which joins the bottom of the groove to the tread band portion of the block. This inclination may coincide with the radial direction or be inclined with respect to the radial direction, for example, by an angle between 0° and 40° as a function of the functional characteristics of the groove.

The term “edge” of a block is intended to be the block region which joins a flank of the block with the tread surface portion of the block. When the block is completely delimited by grooves, therefore, the edge defines the peripheral contour of the tread band portion of the block.

The edge or a portion thereof may be formed by a sharp edge if the wall intersects directly with the tread surface portion or can be formed by a connection surface which connects the wall to the tread surface portion.

The term “recess” of an edge is intended to be an edge portion in which the distance from a longitudinal axis of the groove which it faces has a relative maximum. Typically, a recess is therefore formed by a non-rectilinear edge portion having concavity which is directed towards the groove.

An edge may have a rectilinear progression or curved progression or progression in the form of a broken line, in particular of zigzag. In this last case, it is also referred to as “serrated”.

The term “buttress” is intended to be a block portion which defines a projection which projects from a flank of the block towards the interior of the groove which it faces, and which extends to rest on the bottom of this groove. The buttress is therefore in relief with respect to the flank of the block and to the bottom of the groove.

A tread band element, such as, for example, a block or a component thereof, is viewed “as a top plan view” when it is observed from the exterior of the tread band in a radial direction of the tread band extending through this element.

Two or more edge parts have a “substantially equal” length when the respective lengths differ from each other at most by an extent equal to 10% of the greatest length.

Two or more directions or two or more elements which extend in respective directions, such as, for example, two edge parts, are “substantially parallel” when they are inclined relative to each other by an angle less than 10°, preferably less than 5°.

The overall configuration of the tread band defined by the assembly of grooves and blocks constitutes the tread pattern of the tyre.

The tread pattern may be of the “directional” type, that is to say, configured to be mounted on the vehicle so that the tyre is rotated in a preferential travel direction. This defines on the tread band a preferential rolling direction with respect to which two elements of the tread band, such as, for example, two edges of a block, can be identified as “front” and as “rear” edges, respectively, when rolling in the preferential travel direction the front element moves into contact with the road surface before the rear element.

The Applicant has initially observed that the rigidity of the blocks, understood as being the resistance to deformation in the event of tangential stresses, is a parameter which is particularly relevant in determining the behaviour of a tyre on the road.

In particular, the Applicant has verified that a greater rigidity of the blocks generally involves greater road grip of the tyre.

In fact, in the event of braking, acceleration or travel on bends, the block is subjected to tangential stresses which, in the absence of adequate rigidity, may lead to a relevant deformation thereof and a partial lifting of the block from the road surface, with a resultant reduction in the area of contact between the block and road surface and therefore also of the friction force which is generally applied by the tyre to the road surface.

The Applicant has further observed that the rigidity of the blocks may be substantially reduced when there are formed on the blocks sipes which, as set out above, are widely used in the case of winter tyres for improving the behaviour of the tyre on a snow-bound surface.

The Applicant has further observed that, particularly in winter tyres, one or more flanks of the blocks can have a continuous succession of projections and recesses which develop from the bottom of the groove as far as the respective edge of the block in a direction substantially parallel with the direction of maximum inclination of the flank of the block with respect to the groove.

Said continuous succession of projections and recesses define on the respective edge a zigzag profile or “serrated” profile in which a plurality of consecutive recesses are identified.

This particular conformation of the flank provides the block effectively with new and additional gripping edges, thereby improving the performance levels of the tyre on snow-bound surfaces. Not only this, this formation of the flank allows retention of a greater quantity of snow and also retention thereof in a more effective manner with respect to a flank with a substantially “planar” profile, defining an edge which is substantially parallel with the extent direction of the groove. This allows a further improvement of the capacity for grip of the tyre on snow-bound roads.

However, the Applicant has verified that this formation, by providing a continuous succession of recesses, may in fact reduce the volume and mass of the block, weakening the structure thereof and therefore further reducing the resistance thereof to the tangential stresses.

Therefore, the Applicant has perceived the need to provide a tyre having blocks which, while having one or more flanks with an edge with a zigzag profile, have good rigidity and can therefore provide improved performance levels on dry or wet road surfaces. In seeking to comply with this requirement, the Applicant has observed that the direction of greatest deformation of a flank of the block when it is subjected to tangential deformations is the one directed towards the interior of the groove which it faces.

Therefore, the Applicant has perceived that the formation of the block may be reconfigured in such a manner that, in the region of a plurality of consecutive recesses which are formed on a flank thereof, there may be provided elements capable of acting counter to the deformation of the flank of the block in at least one direction which is directed towards the inner side of the groove.

Finally, the Applicant has found that a block, on an edge of which a plurality of consecutive recesses are defined and in the region of at least two of these recesses there is provided a respective buttress, that is to say, a block portion which defines a projection which projects from the flank of the block towards the interior of the groove and which extends as far as the bottom of the groove, allows to obtain a block which, on the one hand, maintains the capacity for effective retention of snow and, on the other hand, provides greater rigidity.

In particular, in a first aspect thereof, the invention relates to a tyre for vehicle wheels comprising a tread band and a tread surface which is radially external to said tread band.

Preferably, a plurality of blocks is formed on said tread band.

Preferably, each block of said plurality of blocks is at least partially delimited by a groove which defines a flank of the block.

Preferably, there is defined on said block a tread surface portion which is delimited by an edge of said block, which edge joins said tread surface portion to said flank of the block.

Preferably, there is defined on a portion of said edge a plurality of consecutive recesses.

Preferably, in the region of at least two recesses of said plurality of recesses, there is provided a respective buttress, that is to say, a respective block portion which defines a protrusion which projects from said flank of the block towards the inner side of said groove and which extends as far as a bottom of said groove.

The Applicant considers that the provision of the buttresses allows an increase in the rigidity of the block, which is in fact supported laterally in the region of a flank thereof in order to act counter to the deformations of the block towards the inner side of the groove which it faces.

Furthermore, the provision of buttresses precisely in the region of a series of consecutive recesses allows a high number of gripping edges to be maintained and a high capacity for retaining the snow, resulting in optimum behaviour of the tyre on snow-bound road surface.

The present invention, in the above-mentioned aspect, may have at least one of the additional preferred features indicated below.

In some embodiments, each recess of said plurality of recesses is defined by a first edge part and by a second edge part which is consecutive with respect to said first part and which is inclined with respect to said first edge part.

In some embodiments, said first edge parts of said recesses are substantially parallel with each other.

In some embodiments, said second edge parts of said recesses are substantially parallel with each other.

In some embodiments, said first edge parts of said recesses are substantially of the same length.

In some embodiments, said second edge parts of said recesses are substantially of the same length.

In this manner, the first edge parts and the second edge parts generally define a zigzag-like progression of an edge portion.

Preferably, said first edge part is longer than said second edge part, more preferably at least 3 times longer.

In some embodiments, for each of said recesses, said first parts are inclined with respect to said second parts at an angle between 70° and 110°, preferably at approximately 79°.

In some embodiments, said first edge parts are inclined with respect to an extent direction of said groove at an angle between 10° and 30°, more preferably at approximately 15°.

In some embodiments, said second edge parts are inclined with respect to an extent direction of said groove at an angle between 60° and 90°, more preferably at approximately 75°.

In some embodiments, said plurality of recesses comprise at least four recesses.

Preferably, said recesses of said plurality of recesses are substantially identical to each other.

In some embodiments, each buttress, when observed as a top plan view, extends in a longitudinal direction which is inclined with respect to an extent direction of said groove.

Preferably, said longitudinal direction is inclined with respect to the extent direction of the groove at an angle between 10° and 30°, more preferably at approximately 15°.

In some embodiments, said buttresses extend in respective longitudinal directions substantially parallel with each other.

In some embodiments, when observed as a top plan view, said longitudinal direction in which said buttress extends intersects with one of said second edge parts.

In other words, each buttress extends from a portion of the flank of the block defined in a position under one of said second edge parts.

In some embodiments, when observed as a top plan view, said longitudinal direction in which said buttress extends is substantially parallel with said first edge part.

In particular, each buttress, in the region of a respective recess of the edge, extends from a flank portion corresponding to a second edge part in a longitudinal direction parallel with the first edge part, where the recess is defined by the first and second edge parts.

Preferably, each buttress is set against said flank of the block in the region of said first edge part.

In particular, each buttress extends from a portion of the flank of the block defined in a position under one of said second edge parts, remaining set against the flank portion defined in a position under the first edge part.

In some embodiments, each buttress defines a step-like formation comprising at least one side wall which is directed towards the inner side of said groove and an upper wall which is directed radially towards the outer side of the tread band.

Preferably, said upper wall and said side wall of said buttress form a sharp edge.

In this manner, there is provided an additional gripping edge on the block which may be advantageous in the case of travel on a snow-bound road surface.

In some embodiments, said upper wall, in the region of said second edge part, is joined to said flank of the block at a distance from said second edge part of at least 2 mm.

In other words, the buttress extends from the bottom of the groove as far as the flank of the block, but remaining in a lowered position with respect to the second edge part. In this manner, the buttress may perform its support function for the block in the lower portion of the flank, while the upper portion of the flank is left free to perform its function of retaining the snow and having the gripping edges defined by the first edge parts and the second edge parts.

Preferably, said upper wall, in the region of said second edge part, is joined to said flank of the block at a distance from said second edge part equal to a fraction between 30% and 80% of the depth of said groove.

Preferably, said upper wall is substantially planar and continuous.

In some embodiments, said upper wall is inclined with respect to said tread surface portion of said block at an angle between 20° and 60°, more preferably between 30° and 45°.

In other words, the upper wall is in the form of an inclined ramp which extends continuously from the bottom of the groove as far as the flank of the block.

In this manner, the buttress acts as a prop to support the flank of the block in the region of the second edge part. This configuration of the buttress is found to be particularly effective in order to act counter to any deformations of the block in the longitudinal direction of the buttress.

In some embodiments, said buttress is orientated in such a manner that said upper wall faces away from an equatorial plane of said tread band.

In this manner, the buttress is found to be particularly effective for acting counter to any deformations of the block caused by tangential stresses with an axial orientation directed towards the outer side of the tread band. This is found to be particularly effective for increasing the rigidity of the block when driving round a bend, particularly when the block is positioned in a shoulder region of the tread band.

Preferably, said upper wall has a width substantially identical to the extent of said second edge part.

In some embodiments, said flank of the block has, at least in the region of said first edge parts and said second edge parts, the same inclination with respect to a radial direction of said tread band extending through said flank.

Preferably, said flank of the block is inclined with respect to said radial direction at an angle between 0° and 20°, more preferably at approximately 10°.

In some embodiments, the inclination of said side wall of said buttress with respect to a radial direction of said tread band extending through said flank is substantially identical to the inclination of said flank.

Preferably, said side wall of said buttress is substantially parallel with said flank of the block in the region of said first edge part.

In some embodiments, said extent direction of said groove is inclined at an angle between 60° and 90° with respect to a circumferential direction which is defined on said tread band.

As a result, the edge of the block on which the plurality of recesses is formed preferably extends in a direction having a main axial component, thereby being able to be used in a more effective manner.

In some embodiments, said plurality of blocks are positioned in a shoulder region which is defined on said tread band.

Preferably, said plurality of blocks are formed by shoulder blocks.

In some embodiments, there is defined on said tread band a tread pattern of the directional type which provides for a preferential rolling direction of said tyre.

Preferably, said plurality of recesses are formed on a rear edge of said block with respect to said preferential rolling direction.

The features and advantages of the invention will be better appreciated from the detailed description of some preferred embodiments thereof, which are illustrated by way of non-limiting example with reference to the appended drawings, in which:

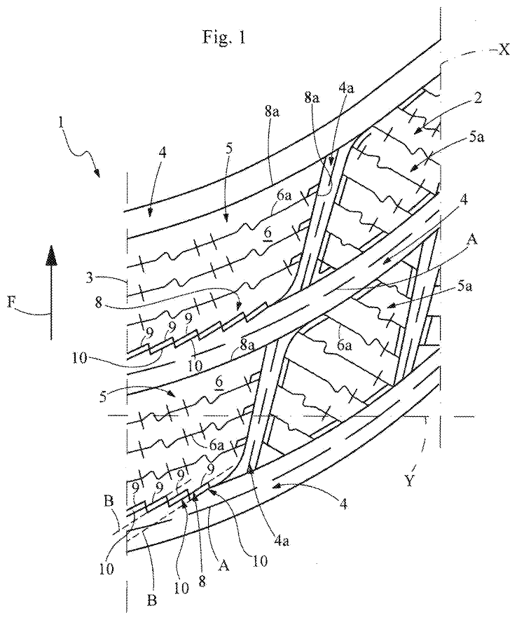

FIG. 1 is a schematic plan view of a tread band portion of a tyre for vehicle wheels constructed according to the present invention,

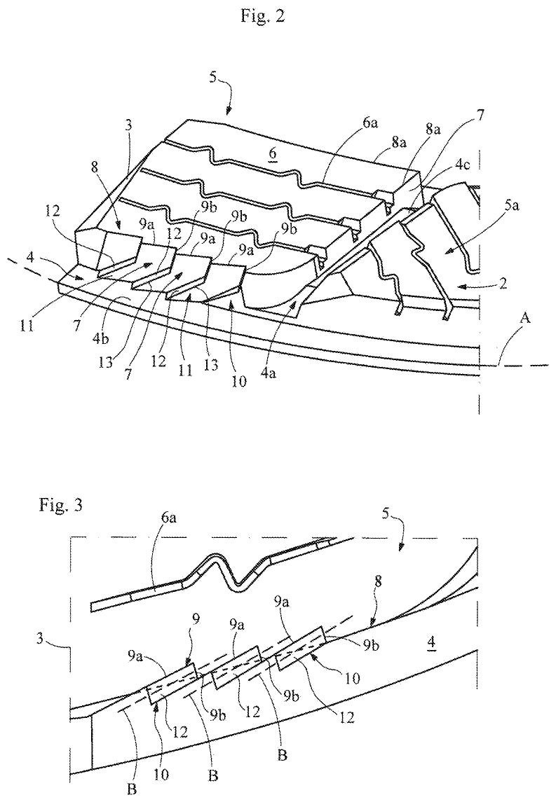

FIG. 2 is a schematic, perspective view, drawn to an enlarged scale, of a block of the tread band of the tyre of FIG. 1,

FIG. 3 is a schematic plan view of a portion of the block of FIG. 2.

With reference to the appended Figures, there is generally designated 1 a tyre for vehicle wheels constructed according to the present invention.

The tyre 1 has a conventional generically toroidal form which develops about a rotation axis, defining an axial direction Y of the tyre, and which is passed through by an equatorial plane which is perpendicular to the rotation axis, defining a circumferential direction X.

The tyre 1 comprises a tread band 2, on which there is defined a tread surface which is arranged in a radially external position with respect to the tread band 2 and which is intended for contact with a road surface.

The tyre 1 has, for example, a nominal section width of approximately 205 mm with a rim diameter of 16 inches.

There remain defined on the tread band 2 a central region which extends circumferentially and symmetrically about the equatorial plane of the tyre and a pair of shoulder regions which extend at the axially opposite sides of the central region, respectively, in an axially external position with respect to the tread band 2 as far as the respective axial ends 3 of the tread band 2.

There are formed on the tread band 2 a plurality of first grooves 4 and second grooves 4a which generally delimit a respective plurality of blocks which are formed on the tread band 2.

The first grooves 4 extend transversely relative to the tread band 2 from the axial end 3 and pass through the shoulder region towards the equatorial plane of the tyre in an extent direction A which is curvilinear.

The first grooves 4 are substantially parallel with each other and have a depth between 7 mm and 9 mm, for example, of approximately 8.5 mm, and a width which is from 4 mm to 9.5 mm.

The second grooves 4a extend so as to connect to each other pairs of first grooves 4 which are arranged one following the other in the circumferential direction X.

The second grooves 4a are substantially rectilinear and inclined with respect to the circumferential direction X at approximately 15° and have a depth between 3 mm and 5 mm and a width of from 2.5 mm to 4 mm.

The extent direction A of the first grooves 4, in an axially external portion thereof near the axial end 3, is inclined at an angle of approximately 70° with respect to the circumferential direction X.

The configuration of blocks and grooves generally defines the tread pattern of the tyre 1 and, in the preferred embodiment described herein, defines a tyre of the directional type, in which there is defined a preferential rolling direction of the tyre which is designated F in FIG. 1.

The blocks which are formed on the tread band 2 can be different in central blocks 5a which are generally delimited by grooves and in shoulder blocks 5 which are delimited in the region of a side thereof by the axial end 3.

A shoulder block 5 is therefore delimited by the axial end 3, by a pair of first grooves 4 and by a second groove 4a which connects the first two grooves 4.

The shoulder block 5 comprises a tread surface portion 6 which is defined on the radially external surface thereof and which is intended for contact with the road surface, and a plurality of flanks 7 which extend towards the tread surface portion 6 from respective bottoms 4b, 4c of the grooves 4 and 4a which delimit the shoulder block 5.

There are further formed on the tread surface portion 6 sipes 6a which are formed in various manners and which are configured to improve the behaviour of the tyre 1 on snow-bound road surfaces.

Each flank 7 extends from the bottom 4b or 4c of the first groove 4 or the second groove 4a towards the tread surface portion 6 with a substantially constant inclination which is slightly divergent with respect to the radial direction of the tyre with which it forms an angle between approximately 2° and approximately 20°, for example, of approximately 5°, approximately 10° or approximately 15°.

Each flank 7 is joined to the tread surface portion 6 in the region of respective edges 8a of the shoulder block 5.

Particularly with reference to the preferential rolling direction F, a rear edge 8 is identified on the shoulder block 5.

The flank 7 of the shoulder block 5 which extends from the rear edge 8 is formed in such a manner that the rear edge 8 has a plurality of consecutive recesses which are all designated 9 and which generally define a zigzag progression of the rear edge 8.

The recesses 9 are substantially identical to each other, in the preferred embodiment described herein there are four or six in accordance with the length of the shoulder block 5 on which they are formed.

Each recess 9 is defined by a first edge part 9a and by a second edge part 9b which is consecutive with respect to the first edge part 9a and which is inclined with respect to the first edge part 9a at an angle, for example, of approximately 79°.

Each first edge part 9a is substantially rectilinear and is inclined with respect to the extent direction A of the first groove 4 which it faces at an angle of approximately 15°.

Each first edge part 9a is approximately 4 mm long and is approximately four times longer than the second edge part 9b with which it forms the recess 9.

The first edge parts 9a of the recesses 9 are further substantially parallel with each other.

Similarly, each second edge part 9b is substantially rectilinear and is inclined at an angle of approximately 75° with respect to the extent direction A of the first groove 4 which it faces. Furthermore, the second edge parts 9b are substantially parallel with each other.

The shoulder block 5 further comprises in the region of each recess 9 which is defined on the rear edge 8 a respective buttress 10, that is to say, a block portion which defines a projection which projects from the flank 7 towards the inner side of the first groove 4 and which extends as far as a bottom 4b of the first groove 4.

In the preferred embodiment described herein, the buttresses 10 are identical to each other but can also take up different formations on the basis of production needs or other functional requirements.

Each buttress 10 defines a step-like formation which starts from a portion of the flank 7 under the second edge part 9b, continues by remaining set against the flank 7 in the region of the first edge part 9a until being connected to the bottom 4b of the first groove 4. The length of the buttress 10, when observed as a top plan view, is substantially identical to the length of the first edge part 9a.

In this manner, the buttress 10 extends in a main longitudinal direction B which is substantially parallel with the first edge part 9a and which is inclined with respect to the extent direction A of the first groove 4 at an angle of approximately 15°.

The longitudinal directions B of the different buttresses 10 which are formed on the shoulder block 5 are substantially parallel with each other.

There is defined on each buttress 10 a side wall 11 which is directed towards the inner side of the first groove 4 and an upper wall 12 which is directed radially towards the outer side of the tread band 2, and which is joined to the side wall 11 by a sharp edge 13. The upper wall 12 is substantially planar and extends continuously from the flank 7 as far as the bottom 4b with an inclination of approximately 45° with respect to the tread surface portion 6.

The upper wall 12 has a width which is substantially identical to the extent of the second edge part 9b.

In the region of the second edge part 9b, the upper wall 12 is joined to the flank 7 at a distance of approximately 5 mm from the second edge part 9b which is equal to approximately 60% of the depth of the first groove 4.

The upper wall 12 therefore defines a type of ramp which rises from the bottom 4b of the first groove 4 and which is supported laterally on the flank portion 7 under the first edge part 9a until being connected to the flank portion 7 under the second edge part 9b.

The side wall 11 of the buttress 10 joins the upper wall 12 to the bottom 4b of the first groove 4 and has a substantially planar formation which is substantially parallel with the flank 7 (in the portion not affected by the buttress 10) in the region of the first edge part 9a.

The buttress 10 which is formed in this manner is therefore orientated in such a manner that the upper wall 12 is directed towards the axial end 3 of the tread band 2 at the side opposite the equatorial plane.

In this manner, the buttress 10 acts as a support element of the flank 7, acting counter to any deformations of the shoulder block 5 as a result of tangential stresses which are applied to the tread surface portion 6 and which are orientated towards the outer side of the tread band 2.

This feature brings about an advantageous increase in the rigidity of the shoulder block 5 which, in terms of performance levels of the tyre 1, results in an improved behaviour on roads with a wet or dry surface.

Furthermore, the provision of the recesses 9 and the buttresses 10 which are lowered with respect to the tread surface portion 6 allows optimum performance levels of the tyre 1 also to be obtained on snow-bound road surfaces.

Naturally, in order to comply with specific and contingent application requirements, a person skilled in the art may apply to the above-described invention additional modifications and variants which are still included within the scope of protection as defined by the appended claims.

For example, in a block in addition to edges which are provided with recesses and respective support buttresses being provided, this may not be limited to the rear edge, but conversely it may be provided in one or more of the different edges of the block.

Furthermore, the provision of edges which are provided with recesses and respective support buttresses may not be limited to a shoulder block but conversely may be provided in any of the blocks or the type of blocks defined on the tread band.

Again, the buttresses may be formed differently from the one described above in accordance with the specific functional requirements by suitably varying dimensions and forms thereof.

1.-15. (canceled)

16. A tyre comprising:
a tread band,
a tread surface radially external to said tread band,
a plurality of blocks formed on said tread band, each block of the plurality of blocks being at least partially delimited by a groove and having:
a flank defined by the groove,
a tread surface portion delimited by an edge of said block, said tread surface portion and said flank joined by said edge,
a plurality of consecutive recesses defined on a portion of said edge,
a respective block portion in the region of at least two recesses of said plurality of consecutive recesses, and
a protrusion defined by the respective block portion, wherein the protrusion projects from said flank of the block towards an inner side of said groove and extends to a bottom of said groove.

17. The tyre according to claim 16, wherein each recess of said plurality of consecutive recesses is defined by a first edge part and by a second edge part, the second edge consecutive with respect to said first part and inclined with respect to said first edge part.

18. The tyre according to claim 17, wherein said first edge part is longer than said second edge part.

19. The tyre according to claim 18, wherein said plurality of consecutive recesses comprise at least four recesses which are substantially identical to each other.

20. The tyre according to claim 19, wherein each of said respective block portions, in a top plan view, extends in a respective longitudinal direction which is inclined with respect to an extension direction of said groove.

21. The tyre according to claim 20, wherein each respective longitudinal direction is substantially parallel with one another.

22. The tyre according to claim 21, wherein, in a top plan view, said each respective longitudinal direction intersects with one of said second edge parts.

23. The tyre according to claim 22, wherein, in a top plan view, said each respective longitudinal direction is substantially parallel with one of said first edge parts.

24. The tyre according to claim 23, wherein each block portion defines a step-like formation comprising:
at least one side wall which is directed towards the inner side of said groove, and
an upper wall which faces radially towards an outer side of the tread band.

25. The tyre according to claim 24, wherein said upper wall, in the region of said second edge part, is joined to said flank of the block at a distance from said second edge part of at least 2 mm.

26. The tyre according to claim 25, wherein said upper wall is substantially planar and continuous.

27. The tyre according to claim 26, wherein said upper wall is inclined with respect to said tread surface portion of said block at an angle between 20° and 60°.

28. The tyre according to claim 27, wherein said block portion is orientated such that said upper wall faces away from an equatorial plane of said tread band.

29. The tyre according to claim 28, wherein said flank of the block has, at least in the region of said first edge parts and said second edge parts, a same inclination with respect to a radial direction of said tread band extending through said flank.

30. The tyre according to claim 29, wherein an inclination of said side wall of said block portion with respect to a radial direction of said tread band extending through said flank is substantially identical to the inclination of said flank with respect to said radial direction.
